(19) United States
(12) Patent Application Publication
(10) Pub. No.: US 2023/0409983 A1
(43) Pub. Date: Dec. 21, 2023

(54) CUSTOMIZABLE FEDERATED LEARNING

(71) Applicant: Cisco Technology, Inc., San Jose, CA (US)

(72) Inventors: Srinivas Siva Kumar Aradhyula, Allen, TX (US); Eugenia Kim, Allentown, PA (US); Myungjin Lee, Bellevue, WA (US); Ali Payani, Santa Clara, CA (US)

(21) Appl. No.: 17/843,264

(22) Filed: Jun. 17, 2022

(51) Int. Cl. G06N 20/20; H04L 67/10; H04L 67/52

(52) U.S. Cl. CPC G06N 20/20; H04L 67/10; H04L 67/52

(57) ABSTRACT

In one embodiment, a controller for a federated learning system identifies a first dataset and a second dataset available to a particular node of the federated learning system. The first dataset comprises features that are common to all nodes of the federated learning system. The second dataset comprises features that are common only to a subset of nodes of the federated learning system. The controller configures the particular node to train a first model using the first dataset. The controller causes formation of a global model in the federated learning system that aggregates the first model from the particular node with models from all other nodes of the federated learning system. The controller configures the particular node to train a second model using the second dataset.

### TECHNICAL FIELD

The present disclosure relates generally to computer networks, and, more particularly, to customizable federated learning.

### BACKGROUND

Machine learning is becoming increasingly ubiquitous in the field of computing. Indeed, machine learning is now used across a wide variety of use cases, from analyzing sensor data from sensor systems to performing future predictions for controlled systems. For instance, image recognition is a branch of machine learning dedicated to recognizing people and other objects in digital images.

Federated learning is a machine learning technique devoted to training a machine learning model in a distributed manner. For instance, a variety of models may be trained at different locations, each having its own training data. In turn, the models from the different locations are then aggregated into a global model. Such a global model typically exhibits increased performance, as it is trained using a robust set of training data from the various locations. In addition, federated learning avoids the data privacy concerns of centralized training approaches whereby the training data would first need to be sent to a central location for model training.

It is often the case that the training data available at the different locations of a federated learning system includes heterogeneous data. For instance, each location may use their own terminology or maintain unique information that is not found at the other locations. Typically, this is addressed by simply excluding the heterogeneous data from being used to train the global model. As a result, the global model is only trained with respect to the common data features shared across the different locations, without regard to the full set of data features available at any given location.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example template for a machine learning workload;

FIG. 4 illustrates an example of a machine learning workload defined in accordance with the template of FIG. 3;

FIG. 5 illustrates an example of a customizable federated learning system;

FIG. 6 illustrates an example of aggregating models for subsets of nodes in a customizable federated learning system; and

FIG. 7 illustrates an example simplified procedure for implementing customizable federated learning.

### DESCRIPTION OF EXAMPLE EMBODIMENTS

### Overview

According to one or more embodiments of the disclosure, a controller for a federated learning system identifies a first dataset and a second dataset available to a particular node of the federated learning system. The first dataset comprises features that are common to all nodes of the federated learning system. The second dataset comprises features that are common only to a subset of nodes of the federated learning system. The controller configures the particular node to train a first model using the first dataset. The controller causes formation of a global model in the federated learning system that aggregates the first model from the particular node with models from all other nodes of the federated learning system. The controller configures the particular node to train a second model using the second dataset.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

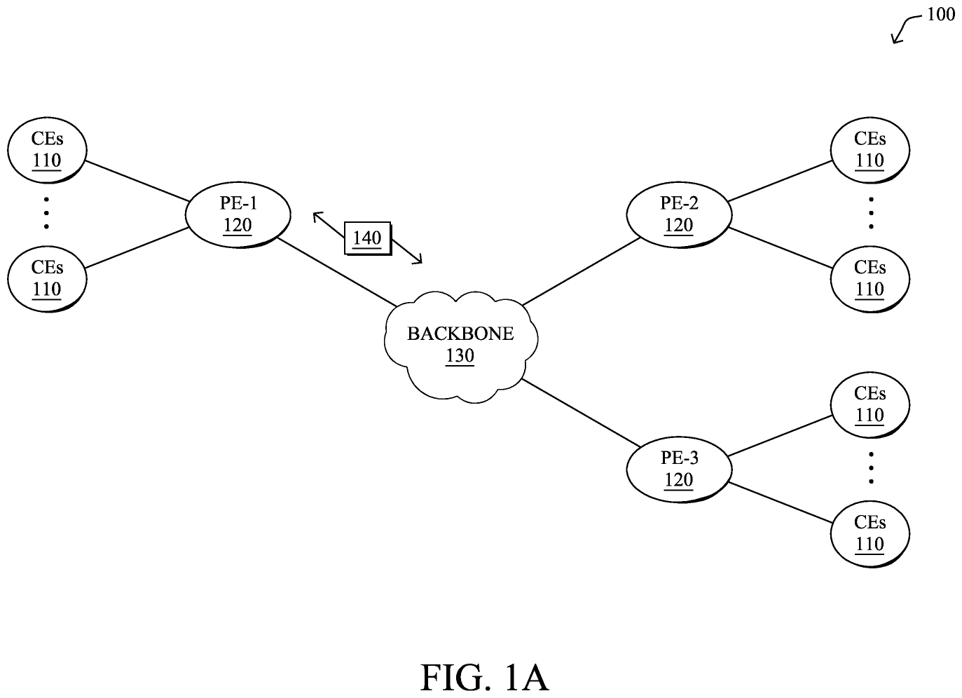

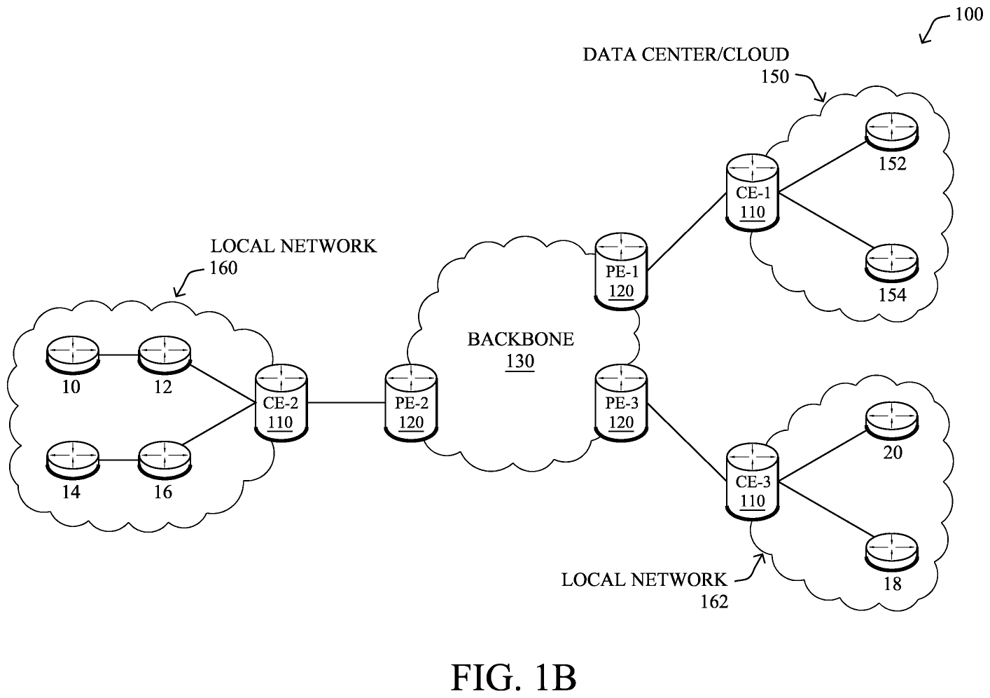

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

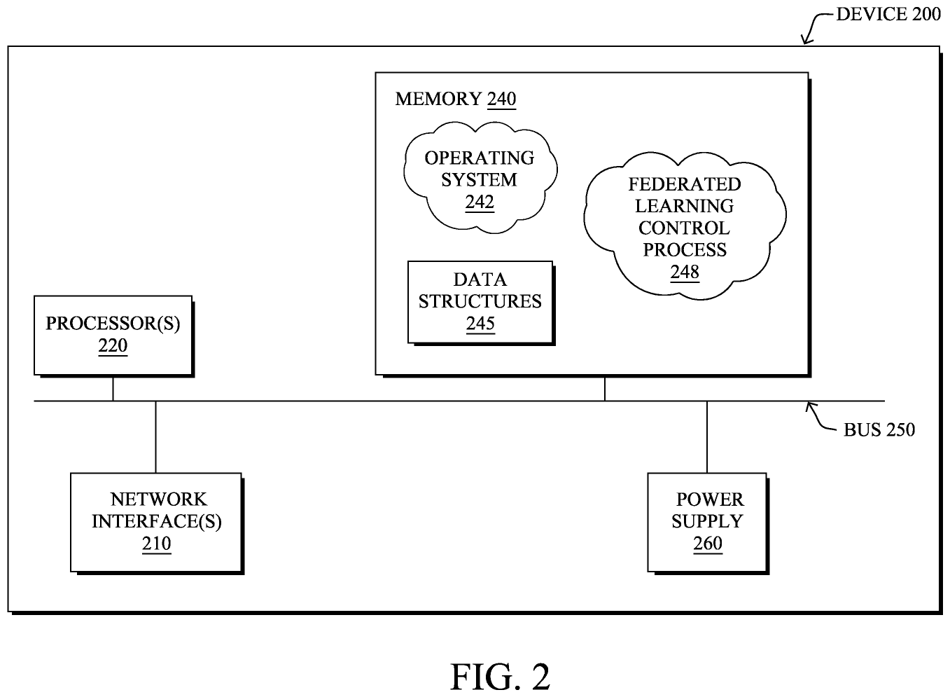

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise federated learning control process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, federated learning control process 248 may also include computer executable instructions that, when executed by processor(s) 220, cause device 200 to perform the techniques described herein. To do so, in some embodiments, federated learning control process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, federated learning control process 248 may employ, or be responsible for the deployment of, one or more supervised, unsupervised, or semi-supervised machine learning models. Generally, supervised learning entails the use of a training set of data, as noted above, that is used to train the model to apply labels to the input data. For example, the training data may include sample image data that has been labeled as depicting a particular condition or object. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that federated learning control process 248 can employ, or be responsible for deploying, may include, but are not limited to, nearest neighbor (NN) techniques (e.g., k-NN models, replicator NN models, etc.), statistical techniques (e.g., B ayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

Unfortunately, running a machine learning workload is a complex and cumbersome task, today. This is because expressing a machine learning workload is not only tightly coupled with infrastructure resource management, but also embedded into the machine learning library that supports the workload. Consequently, users responsible for machine learning workloads are often faced with time-consuming source code updates and error-prone configuration updates in an ad-hoc fashion for different types of machine learning workloads, which may be used to perform tasks such as aggregated model training, performing inferences on a certain dataset, or the like. However, defining a machine learning workload, especially across a distributed set of nodes/sites, can also be a very cumbersome and error-prone task.

To simplify the definition of a workload, the techniques herein propose decomposing machine learning workloads into primitives/building blocks and decoupling core building blocks (e.g., the AMR, algorithm) of the workload from the infrastructure building blocks (e.g., network connectivity and communication topology). The infrastructure building blocks are abstracted so that the users can compose their workloads in a simple and declarative manner. In addition, scheduling the workloads is straightforward and foolproof, using the techniques herein.

In various embodiments, the techniques herein propose representing a machine learning workload using the following building block types:
Role—this is logical unit that defines behaviors of a component. Hence, role contains a software piece. Role allows an artificial intelligence (A machine learning (ML) engineer to focus on behaviors of a component associated with a role. At runtime, a role may consist of one or more instances, but the engineer only needs to work on one role at a time during the workload design phase without the need to understand any runtime dependencies or constraints.
Channel—this is a logical unit that abstracts the lower-layer communication mechanisms. In some embodiments, a channel provides a set of application programming interfaces (APIs) that allow one role to communicate with another role. Some of key APIs are ends( ), broadcast( ), send( ), and recv( ), Function ends( ) returns a set of nodes attached to the other end of a given channel. With this function, a node on one side of the channel can choose other nodes at the other end of the channel and subsequently call send( ) and recv( ) to send or receive data with each node. In some implementations, a channel may eliminate any source code changes, even when the underlying communication mechanisms change.

Roles and channels may also have various properties associated with them, to control the provisioning of a machine learning workload. In some embodiments, these properties may be categorized as predefined ones and extended ones. Predefined properties may be essential to support the provisioning and set by default, whereas extended properties may be user-defined. In other words, to enrich the functionality of the roles and channels, the user/engineer may opt to customize extended properties.

By way of example, a role may have either or both of the following pre-defined properties:
Replica—this property controls the number of role instances per channel. By default, this may be set to one, meaning there is one role instance per channel. However, a user may elect to set this property to a higher value, as desired.
Load Balance—this property provides the ability to load balance demands given to the role instances and to do fail-overs.

For a channel, there may be the following property:
Group By—this property accepts a list of values so that communication between roles in a channel are controlled by using the specified values. For example, this property can be used to control the communication boundary, such as allowing communications only in a specified geographic area in this property (e.g., U.S., Europe, etc.).

Using the above building blocks and properties, the system can greatly simplify the process for defining a machine learning workload for a user.

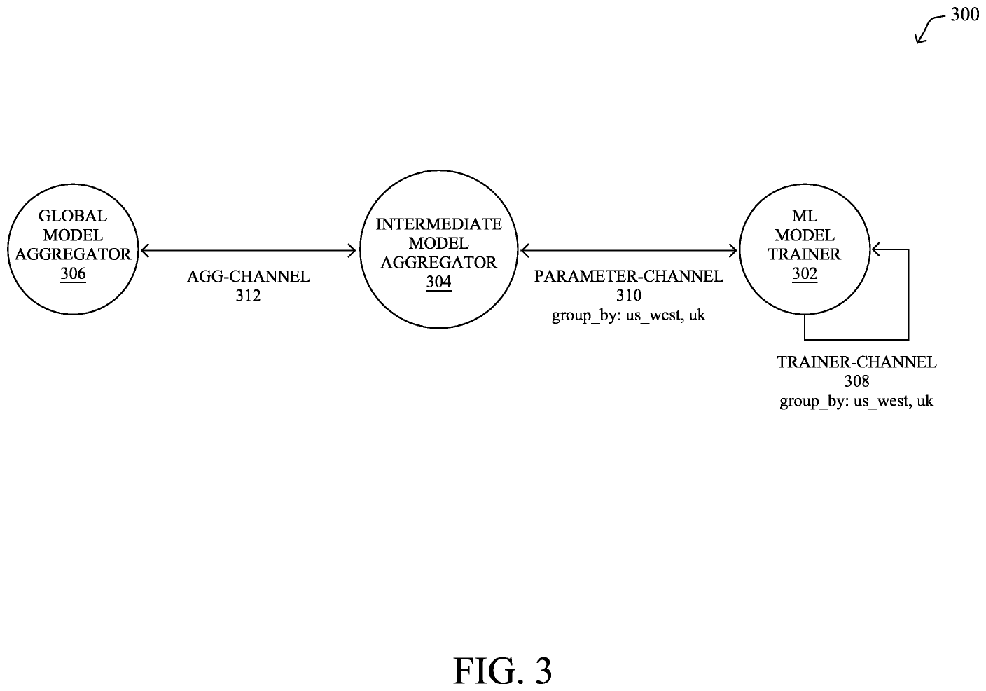

FIG. 3 illustrates an example template 300 for a machine learning workload, according to various embodiments. As shown, assume that a user wants to define a machine learning workload to train a machine learning model using data stored at different geographic locations. In a simple implementation, each site could simply transfer their respective datasets to a central location at which a model may be trained on that data. However, there are many instances in which the data is private, thereby preventing it from being sent off-site. For example, the datasets may include personally identifiable information (PII) data, medical data, financial data, or the like, that cannot leave their respective sites.

As shown, workload design template 300 consists of three roles: machine learning (ML) model trainer 302, intermediate model aggregator 304, and global model aggregator 306. Connecting them in template 300 may be three types of channels: trainer channel 308, parameter channel 310, and aggregation channel 312.

Trainer channels allows communication between peer trainer nodes at runtime. For instance, assume that the group by property is set to group trainer nodes into separate groups located in the western U.S. and the UK. In such a case, trainer channels may be provisioned between these nodes. Similarly, a parameter channel may enable communications between intermediate model aggregators, such as intermediate model aggregator 304 and trainer nodes in the various groups, such as model trainer 302. Finally, an aggregation channel may connect the intermediate model aggregator to global model aggregator 306.

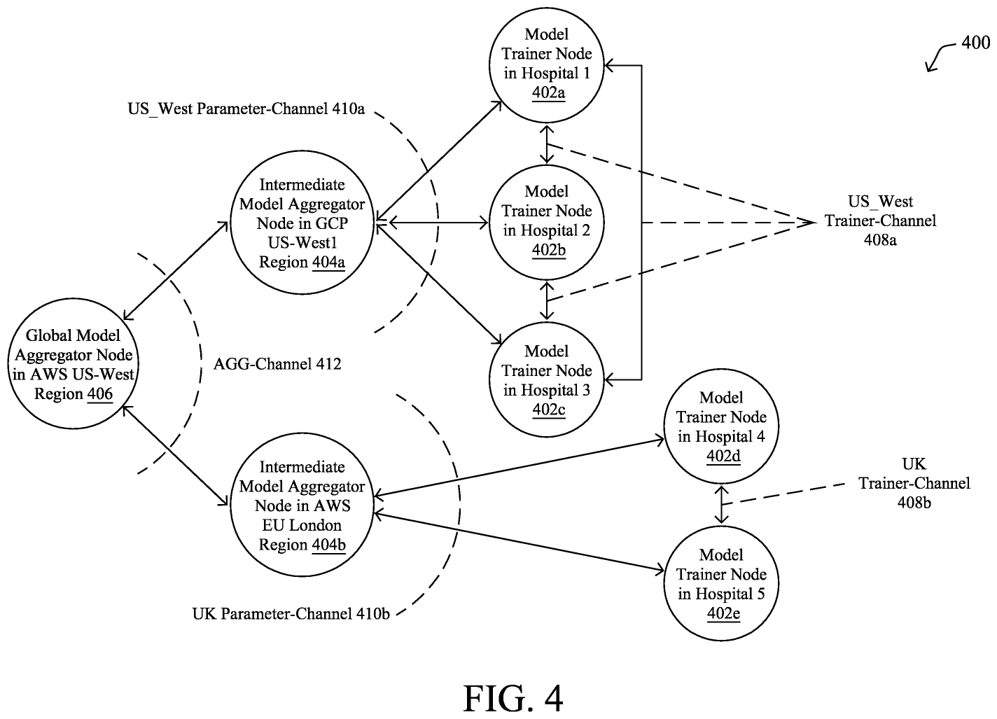

FIG. 4 illustrates an example of a machine learning workload 400 defined in accordance with the template of FIG. 3, according to various embodiments. As shown, assume that the goal of the machine learning workload is to train a machine learning model to detect certain features (e.g., tumors, etc.) within a certain type of medical data (e.g., X-rays, MRI images, etc.). Such medical data may be stored at different hospitals or other locations across different geographic locations. For instance, assume that the medical data is spread across different hospitals located in the UK and the western US, each of which maintains its own training dataset.

To provision the machine learning workload across the different hospitals, a user may convey, via a user interface, definition data for the workload. For instance, the user may specify the type of model to be trained, values for the replica property, the number of datasets to use, tags for the group by property, any values for the load balancing property, combinations thereof, or the like.

Based on the definition data, the system may identify that the needed training datasets are located at nodes 402a-402e (e.g., the different hospitals). Note that the user does not need to know where the data is located during the design phase for machine learning workload 400, as the system may automatically identify nodes 402a-402e, automatically, using an index of their available data. In turn, the system may designate each of nodes 402a-402e as having training roles, meaning that each one is to train a machine learning model in accordance with the definition data and using its own local training dataset. In other words, once the system has identified nodes 402a-402e as each having training datasets matching the requisite type of data for the training, the system may provision and configure each of these nodes with a trainer role.

Assume now that the group by property has been set to group nodes 402a-402e by their geographic locations. Consequently, nodes 402a-402c may be grouped into a first group of trainer/training nodes, based on these hospitals all being located in the western US, by being tagged with a “us_west” tag. Similarly, nodes 402d-402e may be grouped into a second group of training nodes, based on these hospitals being located in the UK, by being tagged with a “uk tag.

For purposes of simplifying this example, also assume that the replica property is set to 1, by default, meaning that there is only one trainer role instance to be configured at each of nodes 402a-402e.

To connect the different sites/nodes 402a-402e in each group, the system may also provision and configure trainer channels between the nodes in each group. For instance, the system may configure trainer channels 408a between nodes 402a-402c within the first geographic group of nodes, as well as a trainer channel 408b between nodes 402d-402e in the second geographic group of nodes.

Once the system has identified nodes 402a-402e, it may also identify intermediate model aggregator nodes 404a-404b, to support the groups of nodes 402a-402c and 402d-402e, respectively. In turn, the system may configure model aggregator nodes 404a-404b with intermediate model aggregation roles. In addition, the system may configure parameter channels 410a-410b to connect the groups of nodes 402a-402c and 402d-402e with intermediate model aggregator nodes 404a-404b, respectively. These parameter channels 410a-410b, like their respective groups of nodes 402, may be tagged with the ‘us_west’ and ‘uk’ tags, respectively. In some instances, intermediate model aggregator nodes 404a-404b may be selected based on their distances or proximities to their assigned nodes among nodes 402a-402e. For instance, intermediate model aggregator node 404b may be cloud-based and selected based on it being in the same geographic region as nodes 402d-402e. Indeed, intermediate model aggregator node 404a may be provisioned in the Google cloud (gcp) in the western US, while intermediate model aggregator node 404b may be provisioned in the Amazon cloud (AWS) in the UK region.

During execution, each trainer node 402a-402e may train a machine learning model using its own local training dataset. In turn, nodes 402a-402e may send the parameters of these trained models to their respective intermediate model aggregator nodes 404a-4041 via parameter channels 410a-410b. Using these parameters, each of intermediate model aggregator nodes 404a-4041 may form an aggregate machine learning model. More specifically, intermediate model aggregator node 404a may aggregate the models trained by nodes 402a-402c into a first intermediate model and intermediate model aggregator node 404h may aggregate the models trained by nodes 402d-402e into a second aggregate model.

Finally, the system may also provision machine learning workload 400 in part by selecting and configuring global model aggregator node 406. Here, the system may configure a global aggregation role to global model aggregator node 406 and configure aggregation channels 412 that connect it to intermediate model aggregator nodes 404a-404b. Note that these aggregation channels may not be tagged with a geographic tag, either.

Once configured and provisioned, intermediate model aggregator nodes 404a-404b may send the parameters for their respective intermediate models to global model aggregator node 406 via aggregation channels 412. In turn, global model aggregator node 406 may use these model parameters to form a global, aggregated machine learning model that can then be distributed for execution. As a result of the provisioning by the system, the resulting global model will be based on the disparate training datasets across nodes 402a-402e, and in a way that greatly simplifies the definition process of the machine learning workload used to train the model.

As noted above, federated learning has garnered increased interest in recent years due to its ability to train more robust AI/ML models, as well as its privacy protecting capabilities. For instance, consider the case of a set of different hospitals across the world, each of which stores X-ray images from their own patients. Sharing such medical information to the cloud for model training, or even between one another, may be undesirable (or even illegal), in many circumstances. With federated learning, however, models can be trained at each of the sites and using their own local data, such as at nodes 402 in FIG. 4. The resulting model parameters can then be aggregated to form a global model that has been trained using the X-ray images across all of the hospitals, but in a manner that does not require those images to actually be shared offsite.

A key challenge that may arise in the above scenario and in other federated learning deployments is that the training data may be heterogeneous across the various sites. For instance, each hospital may use their own terminology and/or may maintain unique information, called “features” in AI parlance, that is not kept by every hospital. Using these types of information during model training can lead to more customized/personalized models and result in higher inference performance. However, because of the heterogeneity of the training data across the sites, this information is often excluded during the initial training of the global model. Then, if personalization is still desired, the global model can be retrained using the new features and additional information available at the local site. Of course, doing so also typically requires a conversion of the model architecture, as well. Consequently, personalization of a globally-trained model in a federated learning system today is often a cumbersome and resource intensive task.

### Customizable Federated Learning

The techniques introduced herein allow for customizable federated learning whereby models may be personalized for a given site using the various types of data available at that site. More specifically, the techniques herein allow for the bifurcated training of models in a federated learning system that accounts for the types of training data available locally and used globally, as well as those types of data that are used only by the local node or a subset of the global set of nodes.

Illustratively, the techniques described herein may be performed by hardware, software, and/or firmware, such as in accordance with federated learning control process 248, which may include computer executable instructions executed by the processor 220 (or independent processor of interfaces 210) to perform functions relating to the techniques described herein.

Specifically, according to various embodiments, a controller for a federated learning system identifies a first dataset and a second dataset available to a particular node of the federated learning system. The first dataset comprises features that are common to all nodes of the federated learning system. The second dataset comprises features that are common only to a subset of nodes of the federated learning system. The controller configures the particular node to train a first model using the first dataset. The controller causes formation of a global model in the federated learning system that aggregates the first model from the particular node with models from all other nodes of the federated learning system. The controller configures the particular node to train a second model using the second dataset.

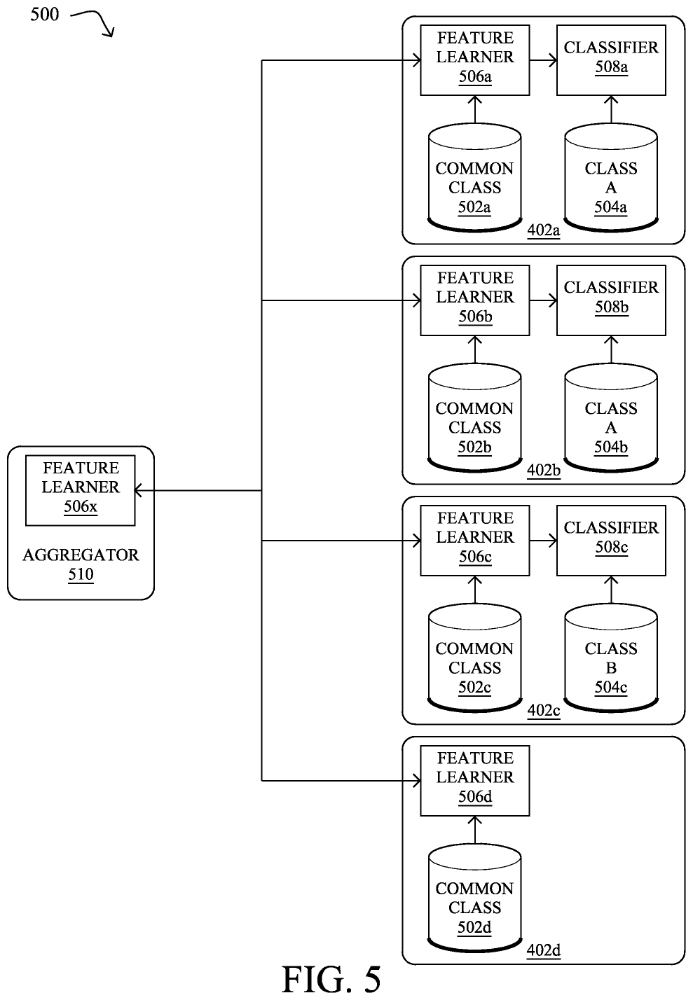

Operationally, FIG. 5 illustrates an example of a customizable federated learning system 500, according to various embodiments. Continuing the example of FIG. 4, from a training perspective, when training a global feature extractor that is combined with the local data and local classification aggregation, the heterogeneity of the classification networks means that the parameters of the feature extractor model cannot simply be aggregated if it is trained using the classification loss function of the node. Alternatively, a common feature extractor could be trained using an unsupervised approach which can be uniform across all nodes. In turn, only this loss function may be used for the common model aggregation or it may be combined with the loss function of the node.

Accordingly, the techniques herein propose the following: each model trainer node 402 is configured (e.g., by controller/supervisor for the federated learning system to conduct customized model training with two separate model architectures:
A first model architecture that performs model training using datasets that share the same feature set as the other model trainers in the learning system.
A second model architecture that is used for training using datasets that include the unique features/additional information of that particular site/node. In some instances, such information may also be available at multiple sites/nodes, but only at a subset of the full set of model trainer nodes 402.

As shown in FIG. 5, consider the case of trainer nodes 402a-402d. Each of these nodes 402 may have access to their own training data 502a-502d that is of a common class/type across nodes 402a-402d, or a common set of classes/types. In addition, some of these nodes may also have access to other training data that is of a class/type that is not found across all of nodes 402a-402d. For instance, nodes 402a-402b may have access to additional training data 504a-504b, respectively, that is of a particular class ‘A.’ Also, node 402c may have access to additional training data 504c that is of a particular class ‘B.’ Node 402d, however, only has access to training data 502d that is of the same class(es)/type(s) as training data 502a-502c available at the other nodes 402 in customizable federated learning system 500.

By way of example, assume that each of nodes 402a-402d is a computing device located at a different hospital and that each of these hospitals maintains electrocardiogram (ECG) measurements for their patients. In such a case, the ECG measurements may be used as training data 502a-502d within customizable federated learning system 500, as part of the training of a global model, as data of this type is common across all of nodes 402a-402d.

In addition to the ECG measurements available at each of nodes 402a-402d, now assume that the hospitals associated with nodes 402a-402b also record whether their patients whose ECG measurements were taken also exhibited jugular venous distension (JVD), a common indicator of congestive heart failure. Such information may constitute training data 504a-504b, as data of this type/class is only available at nodes 402a-402b among the full set of nodes 402a-402d. Similarly, the hospital associated with node 402c may record whether the corresponding patient had previously suffered a heart attack. This information may constitute training data 504c, as it is only available at node 402c.

Identification of the different classes/types of training data available to each of nodes 402a-402d may be achieved in a number of ways, according to various embodiments. In a simplistic approach, a manifest of the different data type(s)/class(es) may be generated for each of the datasets available to nodes 402a-402d. The controller for the federated learning system could then use these manifests to identify the common data type(s)/class(es) available to each of nodes 402a-402d. In such a case, each manifest may express the available datasets as features and their values. However, such manifests may need to be manually generated or curated at each site, greatly increasing the overhead in identifying the commonly-available data. In addition, this also has the potential risk of exposing information about sensitive features.

In an alternate approach, the controller may configure nodes 402a-402d to use a multi-party private set intersection (PSI) protocol, to identify the common type(s) of data available to them, in further embodiments. In general, PSI protocols attempt to identify and reveal only the intersections of datasets across different parties, without revealing anything else about their private datasets. Various approaches can be taken, such as by relying on pseudorandom functions (PRFs). For instance, in a two-party case, a sender may learn a PRF key k, while the receiver learns F(k,r), where F is the PRF and r is the input of the receiver. For more than two parties, the PRF may be modified to allow a sender to program its output on a set of inputs.

Regardless of the precise mechanism that is used to distinguish between the common data type(s)/class(es) and those only shared by a subset of nodes 402a-402d, the controller for customizable federated learning system 500 may then configure bifurcated training tasks on any given node 402. For instance, nodes 402a-402d may each be configured to train a respective feature learner using the common data available to that node. More specifically, node 402a may train a feature learner 506a using training data 502a, node 402b may train feature learner 506b using training data 502b, node 402c may train feature learner 506c using training data 502c, and node 402d may train feature learner 506d using training data 502d.

Similar to the example in FIG. 4, the feature learners 506a-506d trained by nodes 402a-402d may also be aggregated into a global feature learner 506x by an aggregator 510. For simplicity, a single aggregator 510 is shown. However, any number of intermediate aggregators and intermediate models may also be used, in further implementations.

In various embodiments, in addition to the training of the global model using the common class datasets at the trainer nodes 402a-402d, each trainer node may also perform local training in accordance with its other configured learning architecture. Thus, node 402a may also train a classifier 508a using training data 504a, node 402b may train classifier 508b using training data 504b, and node 402c may train classifier 508c using training data 504c. Since node 402d does not have any additional data beyond training data 502d that shares common type(s)/class(es) with the other nodes 402, it does not perform any additional training beyond training feature learner 506d. This functionality can be powerful for building custom models that share similar features, traits, culture, etc., such as due to their geographical proximity. For instance, feature learners 506a-506d may be based data based on common hospital terminology found across the entire set of hospitals, while classifiers 508a-508b may be based on hospital-specific language that is region-specific.

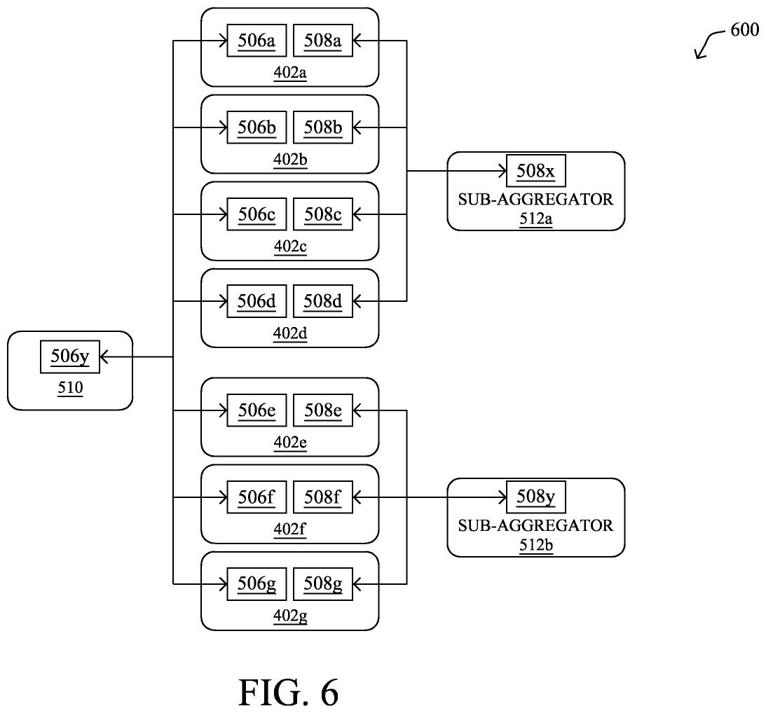

FIG. 6 illustrates an example of aggregating models for subsets of nodes in a customizable federated learning system 600, according to various embodiments. In a further extension of the bifurcated training approach herein, a hybrid approach can also be taken in which models trained using data type(s)/class(es) shared by only a subset of the nodes may also be aggregated.

More specifically, as shown, assume that customizable federated learning system 600 includes nodes 402a-402g, each of which trains a model 506a-506g, respectively, using training data having data type(s)/class(es) that are common across all of nodes 402a-402g. These models 506a-506g may then be aggregated by an aggregator 510 (or multiple aggregators in a hierarchical manner) into a global model 506y.

In addition to training models 506a-506g, nodes 402a-402g may also train models 508a-508g, respectively, using local training data of a type/class (or multiple types/classes) that is not available at each of nodes 402a-402g. Here, the controller for customizable federated learning system 600 may configure sub-aggregators 512a-512b that aggregate the models 508 that were based on common data type(s)/class(es) and/or other parameters. For instance, sub-aggregator 512a may aggregate models 508a-508d into model 508x, while sub-aggregator 512b may aggregate models 508e-508g into model 508y. In other words, nodes 402a-402d constitute a first subset of the nodes 402 sharing at least some features that are not common to all of nodes 402, and nodes 402e-402g constitute a second subset sharing other features that are not common to all of nodes 402. For instance, nodes 402a-402d may be associated with the same entity, geographic region, etc., while nodes 402e-402g are associated with a different entity, geographic region, or the like, resulting in the two subsets having different available features for training.

Of course, while only one aggregation layer is shown in FIG. 6, other hierarchical configurations could also be used to aggregate the models of the different subsets, in further embodiments.

In some embodiments, a group label may be created for each of the different subsets of data type(s)/class(es) used by nodes 402a-402g to train their respective models 508a-508g. In turn, the group label could be used as part of a ‘groupby’ command sent to the controller for customizable federated learning system 600, such as via a user interface. For instance, a hash value (e.g., SHA256 hash) may be computed based on the common features found in a given subset of nodes 402 and used as the group label.

Consequently, customizable federated learning system 600 trains: 1.) a global model 506y that aggregates models 506a-506g trained using common features found across all of nodes 402a-402g, 2.) a specialized model 508x that aggregates the models 508a-508d trained by nodes 402a-402d using features found only at that subset of nodes, and 3.) another specialized model 508y that aggregates models 508e-508g trained by nodes 402e-402g using other features found only at that subset of nodes.

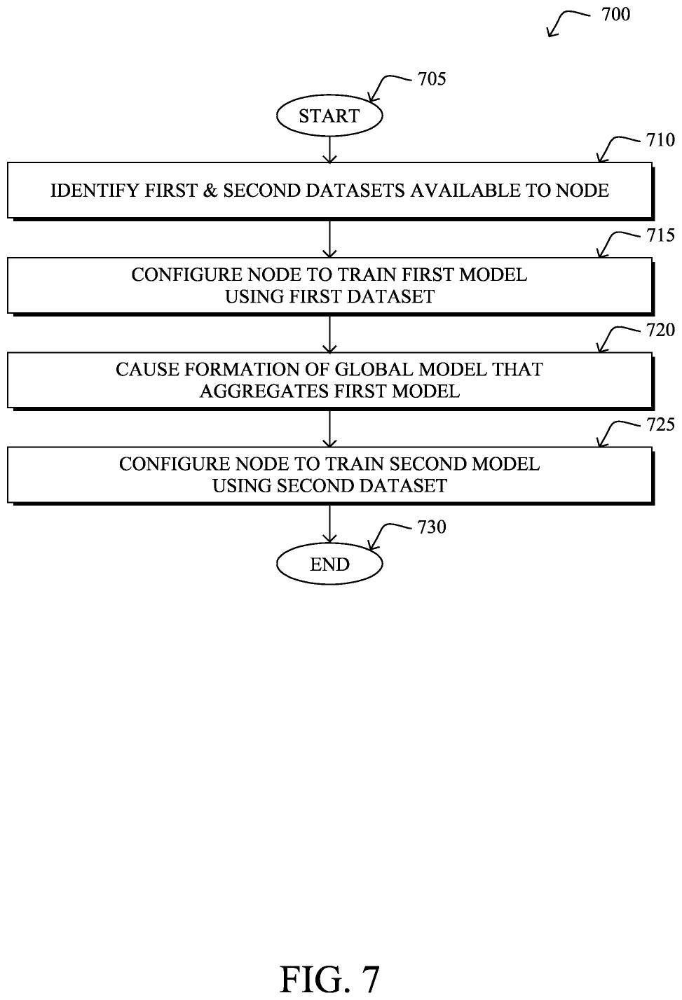

FIG. 7 illustrates an example simplified procedure 700 (e.g., a method) for implementing customizable federated learning, in accordance with one or more embodiments described herein. For example, a non-generic, specifically configured controller for a federated learning system (e.g., device 200), may perform procedure 700 by executing stored instructions (e.g., federated learning control process 248). The procedure 700 may start at step 705, and continues to step 710, where, as described in greater detail above, the controller may identify a first dataset and a second dataset available to a particular node of the federated learning system. In various embodiments, the first dataset comprises features that are common to all nodes of the federated learning system, while the second dataset comprises features that are common only to a subset of nodes of the federated learning system. In various embodiments, the subset of nodes of the federated learning system are associated with a same entity that operates the subset (e.g., the same company, educational institution, hospital system, government or governmental agency, etc.). In further embodiments, the subset of nodes of the federated learning system are located in a same geographic area. In yet another embodiment, the subset comprises only the particular node. In one embodiment, the controller may receive a manifest of data classes available to the particular node. In yet another embodiment, the controller may cause the subset of nodes of the federated learning system to employ a private set intersection protocol, to identify the features that are common only to the subset. In a further embodiment, the features that are common only to the subset are represented as a hash value in the federated learning system. In yet another embodiment, the hash value is used as a group label as part of a command to aggregate models among the subset that are based on the features that are common only to the subset.

At step 715, as detailed above, the controller may configure the particular node to train a first model using the first dataset. For instance, the controller may send an instruction to the particular node with the parameters for the training task (e.g., the type of model to be trained, that the first dataset should be used, etc.). In one embodiment, the controller may do so by

At step 720, the controller may cause formation of a global model in the federated learning system that aggregates the first model from the particular node with models from all other nodes of the federated learning system, as described in greater detail above. In some embodiments, the controller may do so in part by configuring a plurality of intermediate aggregator nodes in the federated learning system.

At step 725, as detailed above, the controller may configure the particular node to train a second model using the second dataset. In various embodiments, the controller may also cause formation of a sub-aggregated model that aggregates the second model from the particular node and one or more models from other nodes in the subset that are trained using the features that are common only to the subset. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for customizable federated learning by bifurcating learning tasks in a federated learning system, and in an automated manner. More specifically, by identifying which types of training data is common to all training nodes vs. those types of training data that is only available on a subset of the nodes. In turn, model training can be bifurcated, essentially forming two federated learning architectures at the same time.

While there have been shown and described illustrative embodiments that provide for customizable federated learning, it is to be understood that various other adaptations and modifications may be made within the spirit and scope of the embodiments herein. For example, while certain embodiments are described herein with respect to machine learning workloads directed towards model training, the techniques herein are not limited as such and may be used for other types of machine learning tasks, such as making inferences or predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
identifying, by a controller for a federated learning system, a first dataset and a second dataset available to a particular node of the federated learning system, wherein the first dataset comprises features that are common to all nodes of the federated learning system, and wherein the second dataset comprises features that are common only to a subset of nodes of the federated learning system;
configuring, by the controller, the particular node to train a first model using the first dataset;
causing, by the controller, formation of a global model in the federated learning system that aggregates the first model from the particular node with models from all other nodes of the federated learning system;
configuring, by the controller, the particular node to train a second model using the second dataset.

2. The method as in claim 1, wherein the subset of nodes of the federated learning system are associated with a same entity that operates the subset.

3. The method as in claim 1, wherein the subset of nodes of the federated learning system are located in a same geographic area.

4. The method as in claim 1, wherein the subset of nodes of the federated learning system comprises only the particular node.

5. The method as in claim 1, further comprising:
causing, by the controller, formation of a sub-aggregated model that aggregates the second model from the particular node and one or more models from other nodes in the subset that are trained using the features that are common only to the subset.

6. The method as in claim 1, wherein identifying the first dataset and the second dataset available to the particular node of the federated learning system comprises:
receiving, at the controller, a manifest of data classes available to the particular node.

7. The method as in claim 1, wherein identifying the first dataset and the second dataset available to the particular node of the federated learning system comprises:
causing, by the controller, the subset of nodes of the federated learning system to employ a private set intersection protocol, to identify the features that are common only to the subset.

8. The method as in claim 1, wherein the features that are common only to the subset are represented as a hash value in the federated learning system.

9. The method as in claim 8, wherein the hash value is used as a group label as part of a command to aggregate models among the subset that are based on the features that are common only to the subset.

10. The method as in claim 1, further comprising:
causing, by the controller, the global model to be sent to the particular node for use.

11. An apparatus, comprising:
one or more network interfaces;
a processor coupled to the one or more network interfaces and configured to execute one or more processes; and
a memory configured to store a process that is executable by the processor, the process when executed configured to:
identify a first dataset and a second dataset available to a particular node of a federated learning system, wherein the first dataset comprises features that are common to all nodes of the federated learning system, and wherein the second dataset comprises features that are common only to a subset of nodes of the federated learning system;
configure the particular node to train a first model using the first dataset;
cause formation of a global model in the federated learning system that aggregates the first model from the particular node with models from all other nodes of the federated learning system;
configure the particular node to train a second model using the second dataset.

12. The apparatus as in claim 11, wherein the subset of nodes of the federated learning system are associated with a same entity that operates the subset.

13. The apparatus as in claim 11, wherein the subset of nodes of the federated learning system are located in a same geographic area.

14. The apparatus as in claim 11, wherein the subset comprises only the particular node.

15. The apparatus as in claim 11, wherein the process when executed is further configured to:
cause formation of a sub-aggregated model that aggregates the second model from the particular node and one or more models from other nodes in the subset that are trained using the features that are common only to the subset.

16. The apparatus as in claim 11, wherein the apparatus identifies the first dataset and the second dataset available to the particular node of the federated learning system by:
receive a manifest of data classes available to the particular node.

17. The apparatus as in claim 11, wherein the apparatus identifies the first dataset and the second dataset available to the particular node of the federated learning system by:
causing the subset of nodes of the federated learning system to employ a private set intersection protocol, to identify the features that are common only to the subset.

18. The apparatus as in claim 11, wherein the features that are common only to the subset are represented as a hash value in the federated learning system.

19. The apparatus as in claim 18, wherein the hash value is used as a group label as part of a command to aggregate models among the subset that are based on the features that are common only to the subset.

20. A tangible, non-transitory, computer-readable medium storing program instructions that cause a controller for a federated learning system to execute a process comprising:
identifying, by the controller, a first dataset and a second dataset available to a particular node of the federated learning system, wherein the first dataset comprises features that are common to all nodes of the federated learning system, and wherein the second dataset comprises features that are common only to a subset of nodes of the federated learning system;
configuring, by the controller, the particular node to train a first model using the first dataset;
causing, by the controller, formation of a global model in the federated learning system that aggregates the first model from the particular node with models from all other nodes of the federated learning system;
configuring, by the controller, the particular node to train a second model using the second dataset.
